(19) United States
(12) Patent Application Publication
(10) Pub. No.: US 2008/0252174 A1
(43) Pub. Date: Oct. 16, 2008

(54) ENERGY HARVESTING FROM MULTIPLE PIEZOELECTRIC SOURCES

(75) Inventors: Farhad Mohammadi, Westampton, NJ (US); Richard B. Cass, Ringoes, NJ (US)

Correspondence Address: PEPPER HAMILTON LLP, 400 BERWYN PARK, 899 CASSATT ROAD, BERWYN, PA, 19312-1183, US

(73) Assignee: Advanced Cerametrics, Inc., Lambertville, NJ (US)

(21) Appl. No.: 11/733,322

(22) Filed: Apr. 10, 2007

(51) Int. Cl. H02N 2/18; H02J 3/00

(52) U.S. Cl. 310/319; 307/84; 310/358

(57) ABSTRACT

Energy harvesting systems and methods that use multiple piezoelectric generators connected to the same energy harvesting circuit with minimal or no energy loss. The piezoelectric energy harvesting system may include individual diode bridge circuits electrically connected to the outgoing wires from each piezoelectric generator. The piezoelectric energy harvesting system may include multiple subsystems each having one or more individual diode bridges electrically connected to the outgoing wires from multiple piezoelectric generators. Multiple subsystems, each having multiple piezoelectric generators and a diode bridge, may be electrically connected to the same energy harvesting circuit. The use of multiple piezoelectric generators connected to the same energy harvesting circuit results in improved energy harvesting capabilities, and a simplified and low cost energy harvesting system.

### TECHNOLOGY FIELD

The present invention generally relates to the field of energy harvesting. More particularly, the present invention relates to systems and methods for electrical energy harvesting from multiple piezoelectric sources.

### BACKGROUND

Piezoelectric materials are used in many applications for actuation, sensing, and electric energy harvesting. Piezoelectricity is the ability of crystals to generate a voltage in response to applied mechanical stress. As such, a mechanical stress applied on a piezoelectric material creates an electric charge. Piezoceramics will give off an electric pulse even when the applied pressure is as small as sound pressure. This phenomenon is called the direct piezoelectric effect and is used in sensor applications such as microphones, undersea sound detecting devices, pressure transducers, and electric energy harvesting to power other electronic devices. Piezoelectric materials can also function quite opposite in the converse piezoelectric effect, in which an electric field applied to a piezoelectric material changes the shape of the material as a result of the applied electric energy. In contrast to the direct piezoelectric effect, the converse piezoelectric effect only causes an elongation/contraction of the dipoles in the material causing the entire material to elongate/contract, and does not produce electrical charges. The converse piezoelectric effect makes possible piezoelectric actuators for precision positioning with high accuracy.

Conventionally, piezoelectric materials may be connected to a circuit containing a diode bridge, a power conditioning circuit, and a capacitor bank. If a mechanical disturbance is applied to the piezoelectric material, energy is generated, conditioned and stored in the capacitor bank. However, if multiple piezoelectric materials are attached to the same circuit in an attempt to produce more electric energy, the energy loss will be very high and there will be less energy stored in the capacitors than if a single piezoelectric transducer was used. The reason for this is that the energy generated from each piezoelectric transducer is consumed by other transducers in the system—that is, the energy generated by one piezoelectric transducer causes the converse piezoelectric effect to occur at the other transducer(s)—resulting in consumption of a part or all of the generated energy. Also, further losses occur due to the destructive electric signal interference produced from each piezoelectric transducer, resulting in less energy available for storage.

For these reasons, traditional single circuits can only handle one piezoelectric generator at a time. If multiple generators are used, less power can be harvested. Also, these traditional single circuit devices are very expensive because each contains its own power conditioning and storage circuitry.

Thus, in view of the foregoing, there is a need for systems and methods that overcome the limitations and drawbacks of the prior art. In particular, there is a need for systems and methods that allow efficient energy harvesting from multiple piezoelectric sources without, or with minimal, energy loss. Embodiments of the present invention provide such solutions.

### SUMMARY

The following is a simplified summary of the invention in order to provide a basic understanding of some of the aspects of the invention. This summary is not intended to identify key or critical elements of the invention or to define the scope of the invention.

The energy harvesting systems and methods of the present invention include the use of multiple energy (e.g., piezoelectric) generators connected to the same energy harvesting circuit (i.e., power condition and storage circuitry) with minimal or no energy loss. The systems and methods using multiple energy generators connected to the same energy harvesting circuit result in improved energy harvesting capabilities, and a simplified and low cost energy harvesting system.

According to one embodiment of the present invention, a piezoelectric energy harvesting system includes individual diode bridge circuits that may be attached to the outgoing wires from each piezoelectric generator. The outgoing wires from each diode bridge may be connected to a single energy harvesting circuit with minimal or no energy loss. This allows for the use of an unlimited number of piezoelectric generators at the same time on the same, or a single, energy harvesting circuit.

According to another embodiment of the present invention, a piezoelectric energy harvesting system includes multiple subsystems each having one or more individual diode bridges that may be connected to the outgoing wires from multiple piezoelectric generators. The outgoing wires from all diode bridges may be connected to a single energy harvesting circuit. Multiple subsystems, each having multiple piezoelectric generators and a diode bridge, may be connected to the same energy harvesting circuit.

The energy generator produces energy and may include any type of generator that produces an alternating current (AC), including for example, piezoelectric generators, magnetic generators, and the like. The energy harvesting system may include the same type of generators or a combination of different types of generators.

According to another aspect of the invention, the piezoelectric energy generators may include piezoelectric ceramic fibers, such as in piezoelectric fiber composites, piezoelectric fiber composite bimorphs, piezoelectric multilayer composites, and the like.

The energy harvesting system may also include power conditioning and storage circuitry. Further, the system may include one or more sensors that may be powered by the energy generator, either directly and/or via stored power. The sensor may include a separate and independent sensor, or the piezoelectric energy generator may also act as a sensor in the system. In addition, a transmitter may be included. In addition, the energy harvesting system may be placed in an enclosure for housing the various components. The enclosure may be mounted to a device to be monitored and that may provide mechanical input to the energy generators.

According to another aspect of the present invention, the multiple power piezoelectric power harvesting system may be compatible to all types of energy harvesting/scavenging circuits. This enables the multiple piezoelectric generator, power harvesting system to efficiently and cost effectively extract electric energy from multiple piezoelectric generator sources with minimal or no energy loss.

Since multiple piezoelectric generators can be used independently without energy loss, each piezoelectric transducer can be tuned to a specific frequency, which results in a multi-frequency, multi-functional energy harvester and/or a single broadband harvester.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. Included in the drawings are the following Figures:

FIG. 1 shows an exemplary system for energy harvesting and sensing of multiple piezoelectric generators each using an independent diode bridge circuit in accordance with an embodiment the present invention;

FIG. 2 is a top view schematic of a multiple piezoelectric generator harvesting system using an independent diode bridge system;

FIG. 3 is a side view schematic of the multiple piezoelectric generator harvesting system of FIG. 2;

FIG. 4 is an alternate embodiment of an energy harvesting system having multiple subsystems each harvesting multiple piezoelectric generators connected to independent diode bridge circuits;

FIG. 5 is an exemplary system for a remote monitoring device using an energy harvesting system having multiple piezoelectric generators and a sensor/wireless communication circuit;

FIG. 6 is a flowchart of an exemplary process of harvesting electrical energy from waste mechanical energy using multiple piezoelectric generators connected to an energy harvesting circuit and for using the harvested electrical energy to power a sensor and wireless device;

FIG. 7 shows an exemplary multilayer piezoelectric fiber composite and method of making the composite;

FIG. 8 shows an exemplary piezoelectric fiber composite for charge generation; and

FIGS. 9A-11B show several exemplary forms that a piezoelectric fiber composite may take.

### DETAILED DESCRIPTION OF ILLUSTRATIVE EMBODIMENTS

The following is a description of several exemplary embodiments of systems and methods for harvesting electrical energy from ambient or waste mechanical energy using multiple energy generators (e.g., piezoelectric generators) with minimal or no energy loss. Energy harvesting is the process by which energy is captured and stored and includes the conversion of ambient energy into usable electrical energy. Energy harvesting generators are devices that convert mechanical energy into electrical energy. Piezoelectric energy harvesting converts mechanical energy to electric energy by stressing a piezoelectric material. This stress in a piezoelectric material causes a charge separation across the device, producing an electric field and consequently a voltage drop proportional to the stress applied. Systems and methods according to embodiments of the present invention include multiple energy generators (e.g., any generators that produce an alternating current (AC)) connected to a single energy harvesting circuit via individual diode bridges.

Embodiments of the present invention include the use of multiple piezoelectric generators connected to an energy harvesting circuit (e.g., power conditioning and storage circuitry) in a manner that results in minimal or no energy loss, such as, for example, energy losses caused by the converse piezoelectric effect. The systems and methods using multiple piezoelectric generators connected via individual diode bridge circuits to the same energy harvesting circuit result in a simplified and low cost system. The multiple generator, energy harvesting systems and methods may be compatible with various types of energy harvesting/scavenging circuits, which enables the energy harvesting system to extract electric energy from multiple piezoelectric generator sources with minimal or no loss.

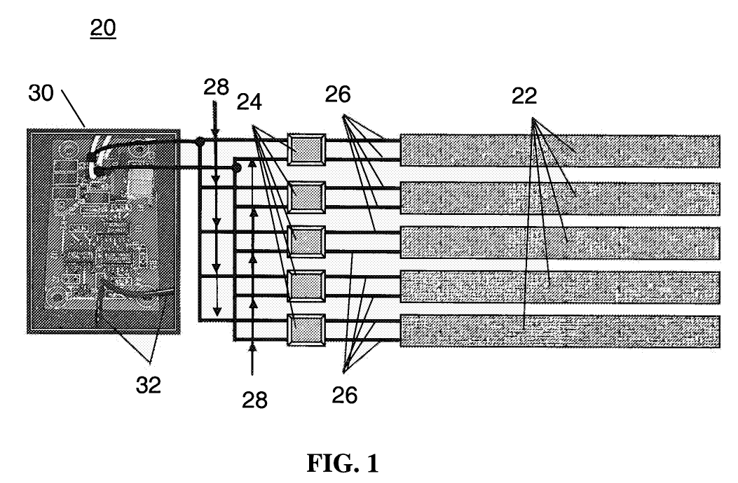

FIG. 1 shows an exemplary embodiment of an energy harvesting and sensing system 20 having multiple energy generators 22 connected to independent diode bridge circuits 24. As shown in FIG. 1, the energy harvesting system 20 includes diode bridges 24 that may be attached to the outgoing wires 26 from each energy generator 22. The outgoing wires 28 from the diode bridges 24 may be connected to a single energy harvesting circuit 30 with minimal or no energy loss.

The energy generator 22 produces energy and may include any type of generator that produces an alternating current (AC). In one preferred embodiment, the energy generator 22 is a piezoelectric generator. The energy generator 22 may include other types of AC generators, such as magnetic generators. The generator may include a piezoelectric and/or electrostrictive material of any type, shape, or size. The multiple energy generators 22 may comprise the same type of generators or a combination of different types of generators. Since multiple piezoelectric generators can be used independently with minimum or no loss, each piezoelectric transducer may be tuned to a specific frequency. This results in a multi-frequency, multi-functional energy harvester and/or a single broadband harvester.

Diode bridge 24 (also referred to and including a bridge rectifier) may include an arrangement of diodes (e.g., typically four) connected in a bridge circuit that provide the same polarity output voltage for any polarity of the input voltage. The diode bridges 24 function to convert Alternating Current (AC) input into Direct Current (DC) output. The size of the diode bridges 24 may vary depending on the particular application for which the diode bridge-circuit is being used. Typically, the size of a diode bridge-circuit increases with increasing power handling capabilities. The diode bridge may include a full or half bridge diode. Semiconductor diodes are preferred due to their low-cost and compact design.

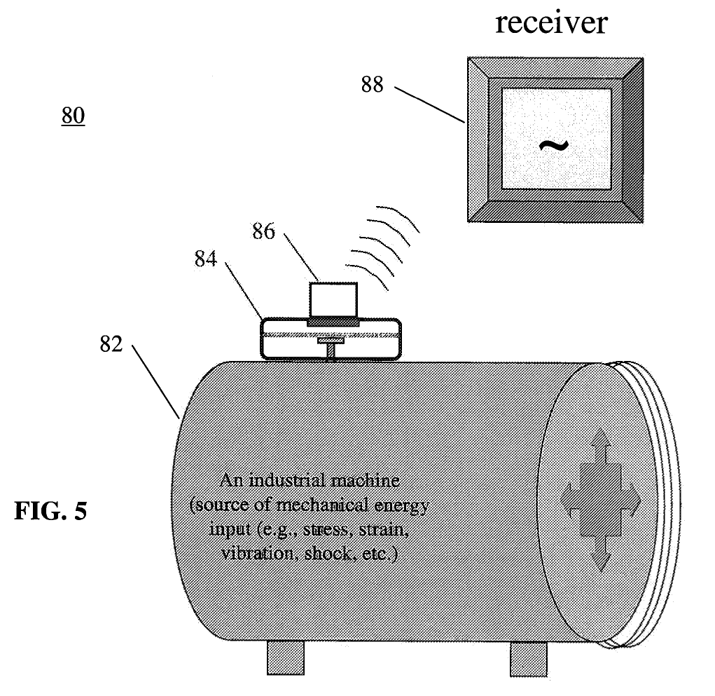

The energy harvesting circuit 30 may include power conditioning circuitry (e.g., control and conversion circuitry) and storage circuitry (e.g., a capacitor). For example, power conditioning circuitry may account for any pulsating magnitude in the DC output using, for example, a smoothing capacitor to lessen the variation (e.g., smooth) the raw output voltage waveform from the diode bridge. Output leads 32 may be provided to extract electrical power from the energy harvesting circuit 30. Power may be extracted directly from the energy harvesting circuit and/or from the storage device of the energy harvesting circuit. The harvested electrical energy may be used to power an electrical device (see FIG. 5). This arrangement of connecting each piezoelectric generator 22 through an independent diode bridge 24 allows the use of an unlimited number of piezoelectric generators 22 at the same time without the use of a corresponding number of energy harvesting circuits 30 and without the occurrence of the converse piezoelectric effect. This design results in cost savings and improved energy harvesting efficiencies, respectively.

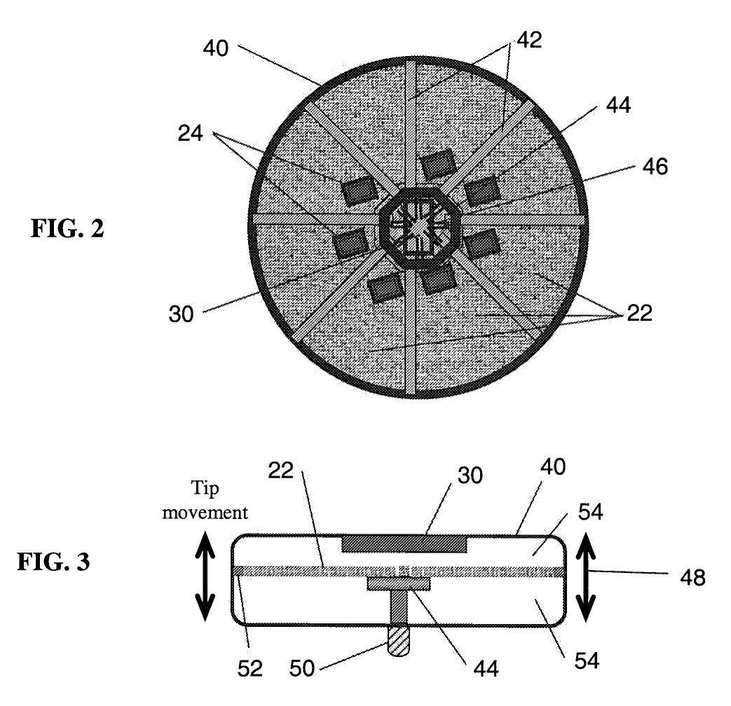

FIG. 2 shows an exemplary multiple piezoelectric power generator, energy harvesting system that is possible using an independent diode bridge system. As shown in FIG. 2, an enclosure 40 may be provided to house the piezoelectric generators 22, diode bridges 24, and the energy harvesting circuit 30. As shown in the exemplary embodiment of FIG. 2, multiple piezoelectric generators 22 may be housed in enclosure 40 and may be electrically connected to the same or a single energy harvesting circuit 30 through independent diode bridges 24. In the illustrated embodiment of FIG. 2, an independent diode bridge 24 is provided for each piezoelectric generator 22. The piezoelectric generators 22 may include the same type of generator or may include multiple types of generators.

As shown in FIGS. 2 and 3, the illustrated exemplary embodiment may include a structure for holding the energy harvesting system. For example, a base 44 and clamp 46 may be provided for this purpose. As shown, the base 44 may extend from the enclosure 40 and hold the piezoelectric generators 22 at one end, for example, in a central region of the enclosure 40. A clamp 46, or other suitable securing device, may be used to hold the piezoelectric generators 22 to the base 44.

An empty space or clearance 42 may be provided between adjacent piezoelectric generators 22 to allow each generator to move and flex independently of adjacent generators. In addition, an empty space or clearance 52 may be provided between each generator 22 and the enclosure 40 (see FIG. 3). The spaces/clearances 42 and 52 help avoid dampening of the energy generators.

As shown in FIG. 2, the enclosure 40 may include a circular shape and the piezoelectric generators 22 may comprise pie-shaped structures arranged in a circular pattern. A space or cavity 54 may be provided above and below the piezoelectric generators 22 to further facilitate free movement of the generators 22. For example, the piezoelectric generators 22 may experience tip movement/deflect as depicted by arrow 48 of FIG. 3. According to embodiments in accordance with the present invention, the generator may be allowed to flex at the ends and may act as a cantilever beam.

The mechanical stress or strain of the piezoelectric generators 22 produces a voltage that may be collected and stored by the energy harvesting circuit 30. Connecting each piezoelectric generator 22 to the energy harvesting circuit 30 via a diode bridge 24, reduces and/or eliminates the converse effect and the associated energy loss, thereby, improving energy harvesting efficiency of the device.

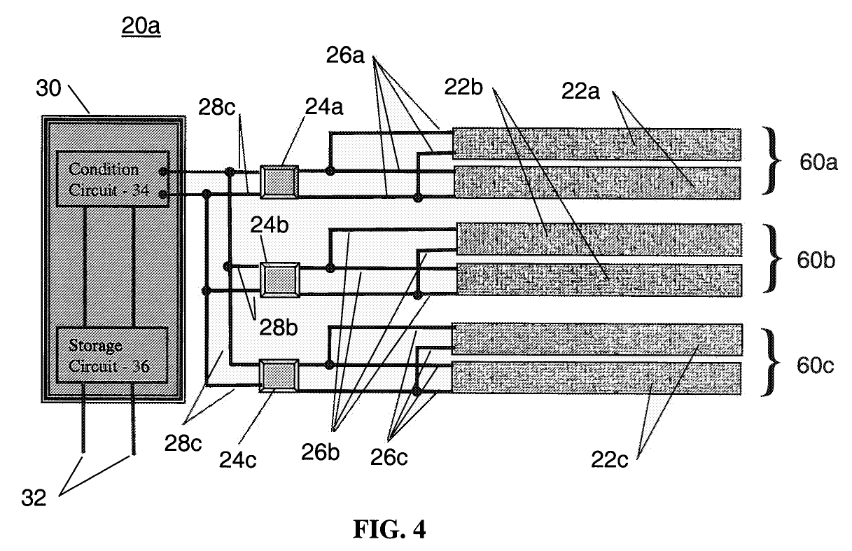

FIG. 4 shows another embodiment of an energy harvesting system 20a having multiple subsystems 60a, 60b, 60c, wherein each subsystem 60a, 60b, 60c includes two or more piezoelectric generators connected to independent diode bridge circuits 24. Each diode bridge 24a, 24b, 24c is then in turn connected to an energy harvesting circuit 30. As will be appreciated by one skilled in the art, the embodiment of FIG. 4 does not necessarily result in no energy loss and/or the same level of improved efficiency that may be expected from the embodiments of FIGS. 1-3. This embodiment does, however, result in reduced energy loss and improved energy harvesting efficiencies as compared to conventional energy harvesting systems.

As shown in FIG. 4, each subsystem 60a, 60b, 60c may include multiple piezoelectric generators 22a, 22b, 22c. As shown, there are two piezoelectric generators 22a, 22b, 22c per subsystem 60a, 60b, 60c. Each subsystem also includes a diode bridge 24a, 24b, 24c. The output leads 26a, 26b, 26c from each group of piezoelectric generators 22a, 22b, 22c in each subsystem 60a, 60b, 60c may be connected to a diode bridge 24a, 24b, 24c of each subsystem 60a, 60b, 60c. The output leads 28a, 28b, 28c of each diode bridge circuit 24a, 24b, 24c may then be connected to the same or a single energy harvesting circuit 30.

As shown, the energy harvesting circuit 30 of FIG. 4 includes a conditioning circuit 34 and a storage circuit 36. The output leads 28a, 28b, 28c from diode bridges 24a, 24b, 24c are electrically connected to the conditioning circuit 34. The conditioning circuit 34 may include, for example, a rectifier. Other electronics may also be provided for conditioning the power prior to storage, such as a transistor, and other electronics for directing and converting the harvested charge to the storage medium. The conditioning circuit 34 is electrically connected to the storage circuit 36. The storage circuit 36 may include a charger capable of capturing and transferring the scavenged energy to a storage device or reservoir, such as a capacitor, capacitor bank, super capacitor, chargeable battery (e.g., thin film lithium-ion battery), or other energy storage device. The energy harvesting circuit 30 includes output leads 32 for outputting electrical power from the energy harvesting circuit 30 to an electrical device, another circuit, such as a transmitter circuit, and the like (not shown in FIG. 4) in order to provide power to the electrical device/circuit.

The embodiment of FIG. 4 may experience some energy loss due to the converse piezoelectric effect. For example, the system illustrated in FIG. 4 may experience such loss between piezoelectric generators 22a of subsystem 60a; between piezoelectric generators 22b of subsystem 60b; and/or between piezoelectric generators 22c of subsystem 60c. However, there is minimal or no energy loss as between independent subsystem 60a, 60b, and 60c, since each includes an independent diode bridge 24a, 24b, 24c connecting the generators 22a, 22b, 22c to the energy harvesting circuit 30. This arrangement results in improved energy harvesting performance as compared to conventional harvesting systems having a single generator and/or multiple generators connected to the energy harvesting circuit via a single diode bridge.

Although three subsystems 60a, 60b, 60c are shown in FIG. 4, the invention is not limited to such an arrangement. Embodiments of the present invention contemplate any arrangement of two or more subsystems. Also, although two generators per diode bridge circuit are also shown in FIG. 4, the invention is not limited to such an arrangement. Embodiments of the present invention contemplate any number of multiple piezoelectric generators connected to a single energy harvesting circuit through two or more diode bridge circuits.

The closer the ratio of piezoelectric generators to diode bridge circuits is to 1:1, the greater the energy harvesting efficiencies and the lower the energy loss caused by the converse effect. A preferred embodiment of the present invention is to have a ratio of piezoelectric generators to diode bridges as close to 1:1 as possible. A more preferred embodiment of the present invention is to have a ratio of piezoelectric generators to diode bridges of 1:1.

FIG. 5 shows an exemplary system 80 for remotely monitoring device 82 using an energy harvesting system 84 having multiple piezoelectric generators, sensors and a wireless communication circuit 86 for communicating with a remote receiver 88. As shown in FIG. 5, waste mechanical energy may be harvested by connecting an energy harvesting system 84 to a source of mechanical energy, such as device 82. For example, energy harvesting system 84 may be mounted to device 82 using a threaded member 50 extending from enclosure 40, as shown in FIGS. 3 and 5. Sensor(s) and a transmitting circuit 86, such as a thermometer and a wireless transmitter, may use power harvested by energy harvesting system 84 to communicate with receiver 88. For example, operation and control of a piece of machinery may be remotely monitored and controlled from a central control center using remote sensors/controllers powered by a multiple piezoelectric generator, energy harvesting system 84.

In addition to powering a sensor and transmitter used to monitor a device, the multiple generator, energy harvesting system may also be used to self-power one or more features of device 82.

Device 82 may include low power devices/systems and/or autonomous devices/systems. For example, the multiple generator, energy harvesting system may be used with devices/systems developed using micro-electromechanical (MEMS) technologies and Nanotechnologies. These devices and systems may be very small and require little power. Scavenging energy from ambient mechanical energy (e.g., stress, strain, vibration, shock, heat, light, motion, bending, flexing, pushing, deflection, RF, EMI and the like) continually replenishes the energy consumed by the device/system thereby extending the lifespan of equipment 82 and enabling device 82 to be functional almost indefinitely.

Device 82 may include any device having moving parts and/or that is in motion, including for example: equipment, machines, wireless devices, portable electronic devices, smart sensors, remote sensors, inaccessible or hard to access devices, embedded devices, micro-devices and micro-systems, MEMS and NANO devices, and the like. The harvested energy may be used to power the entire device 82 and/or to power a portion of the power requirements of the device.

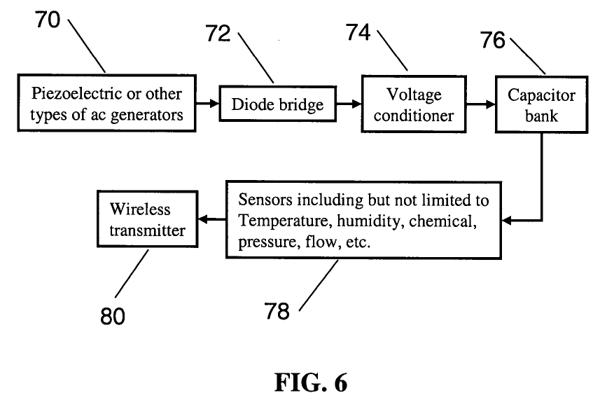

FIG. 6 is a flowchart illustrating an exemplary process of harvesting electrical energy from waste mechanical energy using multiple AC generators and for using the harvested electrical energy to power a device, such as a wireless communication device. As shown, ambient energy is scavenged at step 70 using multiple piezoelectric, or other types of AC, generators. At step 72, the scavenged AC energy is rectified. The energy is conditioned at step 74 and stored in a suitable storage device at step 76. The stored energy may then be used to power one or more sensors at step 78. The sensors may monitor, for example, temperature, humidity, chemistry, pressure, flow, accelerometer, precipitation, wind, speed, body fluids and functions, etc. The stored energy may also be used to power a wireless transmitter. The transmitter may be used to communicate, at step 80, with other remote devices, a relay station, a central control station, and the like. Preferably, the device supports two-way communications and is capable of transmitting and receiving data and other information, such as, for example, operational data, status data, service data, control data, and the like.

The AC generator may be used to produce energy that may be collected to power other, independent sensors (such as, for example, chemical sensors). Also, AC generators made of a piezoelectric material may act as sensors to perform some tasks (e.g., in lieu of a separate sensor for one or more of the sensors identified in step 78 above). Exemplary applications where a piezoelectric generator may also act as a sensor include pressure and accelerometer applications. Use of the piezoelectric generator as a sensor eliminates an extra system component (i.e., a separate and independent sensor device).

The AC generators may include piezoelectric and/or electrostrictive materials. Piezoelectric materials exhibit a distinctive property known as the piezoelectric effect. Piezoelectric materials come in a variety of forms including crystals, plastics, and ceramics. Piezoelectric ceramic materials are essentially electromechanical transducers with special properties for a wide range of engineering applications. When subjected to mechanical inputs, such as stress from compression or bending, an electric field is generated across the material, creating a voltage gradient that generates a current flow. The piezoelectric ceramic material energy harvesting system of the present invention collects this electrical response and stores it for future use in powering an electrical circuit and/or device. Further, the piezoelectric ceramic materials may also act as sensors in applications such as acceleration, pressure, flex or other motion.

The multiple generator, energy harvesting system preferably includes advanced, high charge piezoelectric ceramic fibers (PZT, PLZT, or other electro-chemistries), rods, foils, composites, or other shapes (hereinafter referred to as “piezoelectric ceramic fibers”). Piezoelectric ceramic fibers produced by the Viscose Suspension Spinning Process (VSSP) are one example of advanced, high charge piezoelectric ceramic fibers. VSSP is a relatively low-cost technology that can produce superior fibers ranging from about 10 microns to about 250 microns. Methods of producing ceramic fibers using VSSP are disclosed, for example, in U.S. Pat. No. 5,827,797 and U.S. Pat. No. 6,395,080, the disclosures of which are incorporated herein by reference in their entirety.

In a preferred embodiment, the power generators 22 comprise piezoelectric ceramic fiber and/or fiber composite materials developed and manufactured by Advanced Cerametrics, Inc. of Lambertville, N.J.

The piezoelectric ceramic fibers may be formed to user defined (shaped) composites based on specific applications and devices. The piezoelectric ceramic fibers may be disposed in, attached to, and/or embedded in the device to be monitored or housed in a separate enclosure that may then be mounted to a device to be monitored (see FIG. 5).

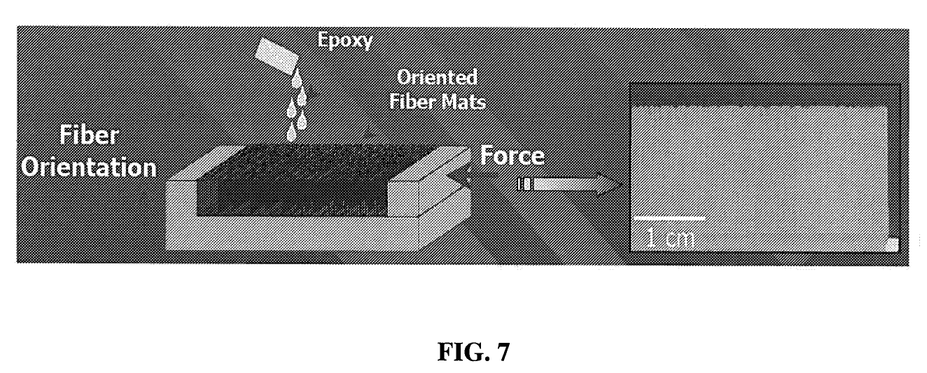

The piezoelectric ceramic fibers are preferably positioned and oriented so as to maximize the excitement of the fibers. In one embodiment, the piezoelectric ceramic fibers may be oriented in a parallel array with a poling direction of the fibers being in substantially the same direction. As shown in FIG. 7, a fiber composite may include a plurality of individual fibers of piezoelectric ceramic material disposed in a matrix material (e.g., a polymer matrix). As shown, the fiber composite includes opposing sides, which may be substantially planar and parallel to one another. The fiber composites may also include electrodes on each side from which extend electrical leads 26, respectively. The electrodes may include interdigital electrodes. One of the electrodes may be a positive terminal and the other may be a negative terminal. Electrodes can be used to collect the charge generated by the piezoelectric fibers. It should be understood that other configurations of the fiber position and orientation are within the scope of the invention. For example, the fibers may be at an angle (other than parallel or normal) to the opposing sides.

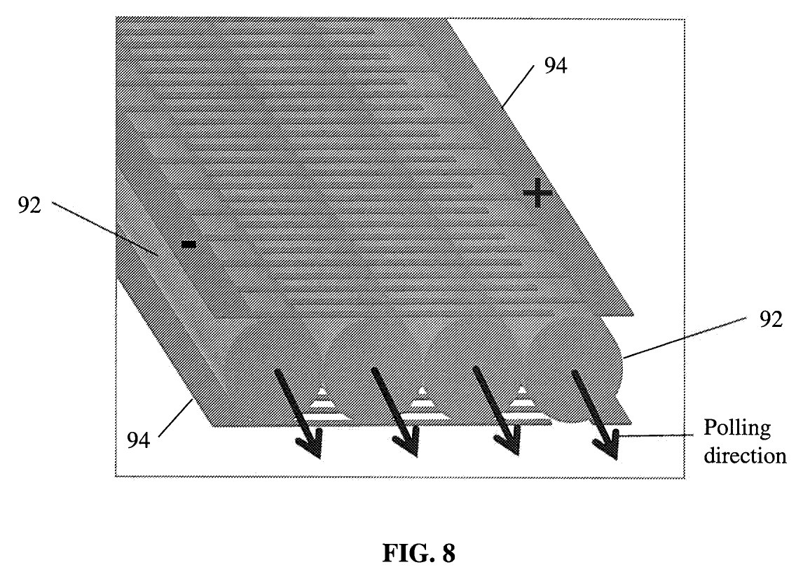

The energy generators 22 may also include processing of multilayer piezoelectric fiber composites. Processes for producing multilayer piezoelectric fiber composites are disclosed, for example, in U.S. Pat. No. 6,620,287, the disclosure of which is incorporated herein by reference in its entirety. As shown in FIG. 8, an exemplary multilayer piezoelectric fiber composite may include fine sheets of parallel oriented piezoelectric fibers in the z-direction. As shown, the piezoelectric fiber composite includes fibers 92 disposed between electrodes 94 and which may be held within a polymer (not shown). Preferably, sheet separation, volume fraction of ceramic, size and geometry can be tailored to the particular application during the manufacturing process.

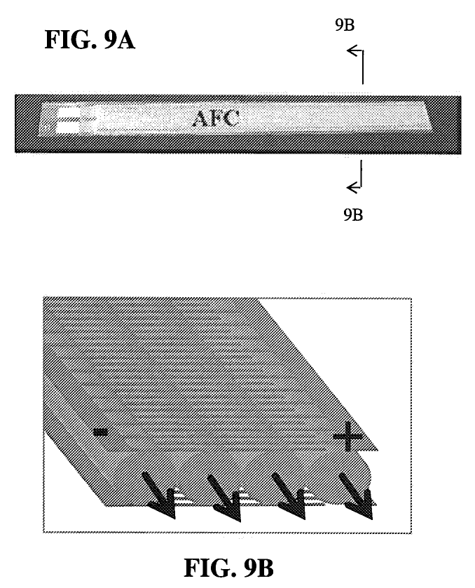

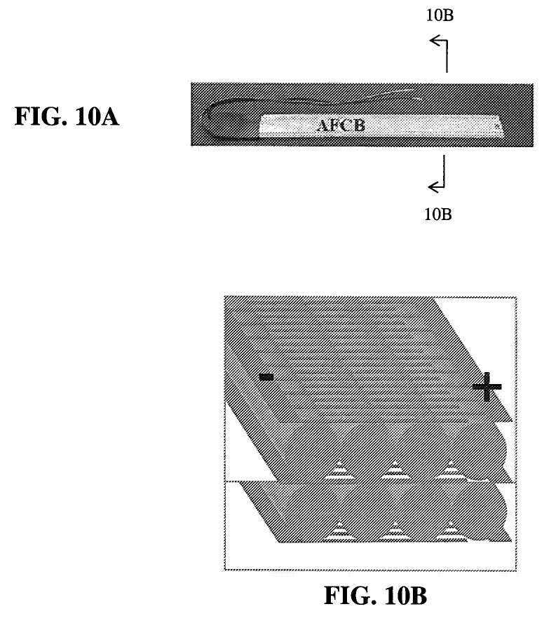

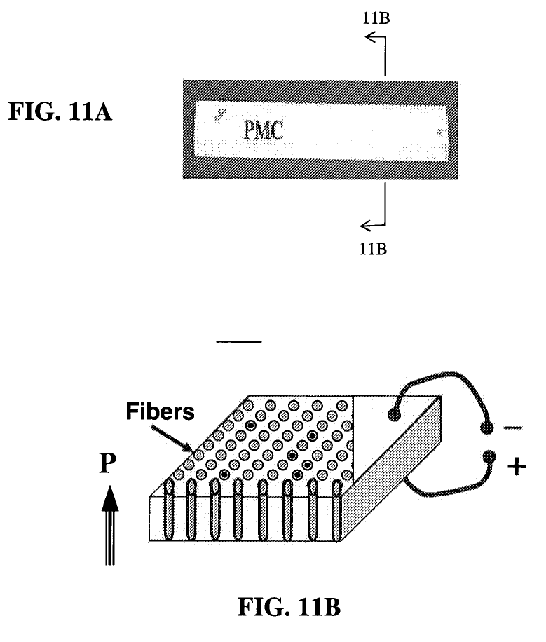

As shown in FIGS. 9A-11B, the multiple piezoelectric generator, energy harvesting system 20 may include piezoelectric ceramic fibers in various forms, including, for example, a piezoelectric fiber composite (PFC) (FIGS. 9A and 9B), a piezoelectric fiber composite bimorph (PFCB) (FIGS. 10A and 10B), a piezoelectric multilayer composite (PMC) (FIGS. 11A and 11B), etc. PFC comprises a flexible composite piece of fibers that may be embedded in an epoxy, a laminated piece, and/or other structure of the device. PFCB comprises two or more PFCs connected together, either in series or in parallel, and attached to a shim or a structure of the device. PMC can include fibers oriented in a common direction and typically formed in a block type or other user defined shapes and sizes.

A typical single, PFC may generate voltages in the range of about 40 Vp-p from vibration. A typical single, PFCB (bimorph) may generate voltages in the range of about 400 Vp-p with some forms reaching outputs of about 4000 Vp-p. As a way of illustration, VSSP produced piezo fibers have the ability to produce about 1 J of storable energy in about a 10 second period when excited using a vibration frequency of 30 Hz.

Preferably, the piezoelectric ceramic fibers are used as long as possible for the given application. Generally, the longer the fiber, the more active materials and hence more charge that may be generated for a given mechanical energy input. Accordingly, elongate fibers are preferably positioned and oriented to maximize the length of the fibers thus providing for increased amounts of harvested charge/power.

In addition, generally, the amount of active materials and hence charges increases as the number of fibers increases. As such, more charge may be generated for a given mechanical energy input by increasing the number and concentration of the fibers. For example, in one embodiment the fibers are positioned so that adjacent fibers are in contact with one another (although spacing may be provided between adjacent fibers). Accordingly, the fibers are preferably positioned and oriented to maximize the number and concentration of the fibers thus providing for increased amounts of harvested charge/power.

The piezoelectric energy harvesting system power scavenging capacity is determined, at least in part, by the number and type of piezoelectric generators. As a general rule, the more generators, the more power that may be generated. The piezoelectric generators power capacity and output power is determined, at least in part, by the number or amount of piezo fibers, the amount of active materials, the material(s) of the piezo fiber, the size and form factor of the fibers/composite, and the mechanical forces (stress and strain) and frequencies. Functional or useful amounts of power may be measured in microwatt, milliwatt and nanowatts levels.

Advantages and benefits of the multiple piezoelectric generator, energy harvesting system include: improved energy harvesting efficiencies; reduced energy loss due to the converse piezoelectric effect; greater power generation and storage from multiple generators; reduce/eliminate dependency on external power sources; reduce/eliminate dependency on batteries; eliminate battery replacement and battery disposal; make more portable by, for example, reducing/eliminating dependency on a power cord and charging station; reduce the size (smaller) of the portable electronic device by, for example, having the fibers conform to the shape of the device; reduce the weight (lighter) of the portable electronic device (piezoelectric ceramic fiber solutions typically weigh a few grams and not several ounces as are other types of power systems); reduce the cost (cheaper) of the portable electronic device; enhance the service life of the electronic device; improve the reliability of the portable electronic device; provide a more robust design (generally the more energy encountered the more power generated) (e.g., PFC's and PMC's can withstand a hammer strike without damage); reduce the maintenance and life cycle costs of owning and operating the portable electronic device; conversion of a higher percentage (up to about 70% or more) of energy from ambient mechanical sources to electrical power using piezoelectric active fibers; improved performance over an extended life cycle; improve the overall quality of the portable electronic device; improving the operating experience for the user of the portable electronic device.

While the present invention has been described in connection with the exemplary embodiments of the various Figures, it is not limited thereto and it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. An energy harvesting system comprising:
two or more energy generators;
an independent diode bridge circuit electrically connected to each of said energy generators; and
a single energy harvesting circuit electrically connected to an output of each of said independent diode bridge circuits.

2. The energy harvesting system of claim 1, wherein said energy generators further comprise piezoelectric energy generators.

3. The energy harvesting system of claim 2,wherein said piezoelectric energy generators further comprise piezoelectric ceramic fibers.

4. The energy harvesting system of claim 3, wherein said piezoelectric ceramic fibers further comprise one or more of: a piezoelectric fiber composite; a piezoelectric fiber composite bimorph, and/or a piezoelectric multilayer composite.

5. The energy harvesting system of claim 1, wherein said energy harvesting circuit further comprises:
power conditioning circuitry; and
power storage circuitry.

6. The energy harvesting system of claim 1, wherein said energy harvesting system is compatible with various types of energy harvesting circuits.

7. The energy harvesting system of claim 1, wherein said piezoelectric energy generators further comprise piezoceramic materials.

8. The energy harvesting system of claim 1, further comprising a sensor electrically connected to an output of said energy harvesting circuit.

9. The energy harvesting system of claim 1, wherein said energy generator acts as a sensor.

10. The energy harvesting system of claim 1, further comprising a transmitter circuit electrically connected to an output of said energy harvesting circuit.

11. The energy harvesting system of claim 1, wherein each energy generator may be tuned to a specific frequency resulting in a multi-frequency, multi-functional energy harvester and/or a single broadband harvester.

12. The energy harvesting system of claim 1, further comprising an enclosure for housing said energy generators, said diode bridge circuits, and said energy harvesting circuit.

13. An energy harvesting system comprising:
an energy harvesting circuit;
two or more energy harvesting generator subsystems electrically connected to said energy harvesting circuit;
each energy harvesting generator subsystem comprising:
two or more energy generators; and
an independent diode bridge circuit connected to at least two of said energy generators.

14. The energy harvesting system of claim 13, wherein said energy generators further comprise piezoelectric energy generators

15. The energy harvesting system of claim 14, wherein said piezoelectric energy generators further comprise piezoelectric ceramic fibers.

16. The energy harvesting system of claim 15, wherein said piezoelectric ceramic fibers further comprise one or more of: an active fiber composite; an active fiber composite bimorph, and/or a piezoelectric multilayer composite.

17. The energy harvesting system of claim 13, wherein said energy harvesting circuit further comprises:
power conditioning circuitry; and
power storage circuitry.

18. The energy harvesting system of claim 13, further comprising a sensor and a transmitter electrically connected to said energy harvesting circuit.

19. The energy harvesting system of claim 13, wherein one or more of said energy generators further comprises a piezoelectric energy generator, wherein one or more of said piezoelectric energy generators acts as a sensor.

20. The energy harvesting system of claim 13, further comprising an enclosure for housing said energy generators, said diode bridge circuits, and said energy harvesting circuit.

21. The energy harvesting system of claim 13, wherein each energy generator may be tuned to a specific frequency resulting in a multi-frequency, multi-functional energy harvester and/or a single broadband harvester.

22. An energy harvesting system comprising:
one or more energy generators;
an independent diode bridge circuit connected to each of said energy generators;
one or more energy harvesting generator subsystems, each subsystem comprising:
two of more subsystem energy generators;
an independent subsystem diode bridge circuit connected to two or more of said subsystem energy generators;
an energy harvesting circuit electrically connected to:
an output of each of said independent diode bridge circuits; and
to each of said independent subsystem diode bridge circuits.

23. The energy harvesting system of claim 22, wherein said energy generators further comprise piezoelectric energy generators.

24. The energy harvesting system of claim 23, wherein said piezoelectric energy generators further comprise piezoelectric ceramic fiber energy generators.

25. A method of harvesting electrical energy from ambient mechanical energy with minimal or no energy loss, said method comprising:
generating an electrical charge in response to an applied mechanical stress using multiple AC generators;
converting AC input from said multiple AC generators to DC output using an independent diode bridge circuit electrically connected to each AC generator;
storing said DC output from each of said independent diode bridge circuits to a single energy harvesting circuit as harvested electrical energy; and
reducing and/or eliminating energy loss due to the converse piezoelectric effect in an energy harvesting system having multiple AC generators.

26. The method of claim 25, further comprising forming said AC generators from a piezoelectric material.

27. The method of claim 26, further comprising forming said piezoelectric AC generators as piezoelectric ceramic fibers.

28. The method of claim 25, further comprising conditioning said DC output prior to storing said harvested electrical energy.

29. The method of claim 25, further comprising:
sensing a condition;
powering a transmitter circuit using said harvested electrical energy; and
transmitting said sensed condition.

30. The method of claim 29, further comprising powering said transmitter circuit using said stored harvested electrical energy.

31. The method of claim 25, further comprising:
electrically connecting an electrical device to an output of said energy harvesting system; and
powering said electrical device using said harvested electrical energy.

32. The method of claim 31, further comprising powering said electrical device using said stored harvested electrical energy.

33. An energy harvesting system comprising:
an energy harvesting circuit;
two or more diode bridge circuits electrically connected to said energy harvesting circuit; and
one or more piezoelectric generators electrically connected to each of said diode bridge circuits.

34. The energy harvesting system according to claim 33, wherein a ratio of said piezoelectric generators to said diode bridge circuits is 1:1.

35. The energy harvesting system according to claim 33, wherein at least one diode bridge circuit has a ratio of said piezoelectric generators to said diode bridge circuits of 1:1, and at least one diode bridge circuit has a ratio of said piezoelectric generators to said diode bridge circuits of 2:1 or greater.
